(19) United States
(12) Patent Application Publication
(10) Pub. No.: US 2015/0007735 A1
(43) Pub. Date: Jan. 8, 2015

(54) MEANS FOR COMPRESSING PAPER STACK HEIGHT AND METHOD FOR CONTROLLING PAPER STACK HEIGHT OF PAPER PRODUCT

(71) Applicant: CHAN LI MACHINERY CO., LTD., TAOYUAN (TW)

(72) Inventor: CHI PIN HSU, TAOYUAN (TW)

(73) Assignee: CHAN LI MACHINERY CO., LTD., TAOYUAN (TW)

(21) Appl. No.: 14/053,770

(22) Filed: Oct. 15, 2013

(30) Foreign Application Priority Data
Jul. 3, 2013 (TW) 102123891

(51) Int. Cl. B65B 63/02; B30B 15/16

(52) U.S. Cl. CPC B65B 63/028; B30B 15/16
USPC 100/35; 100/43

(57) ABSTRACT

The present invention provides a means for compressing paper stack height and method for controlling paper stack height, the means mainly comprising at least one pressurizer and at least one elevator, the elevator being allowed for adjusting up/down position of the pressurizer on the basis of paper stack height of paper product, correspondingly, the pressurizer in the adjusted position being allowed for pressurizing each paper product, in turn, by means of a pressure plate, in such a way that paper stack height of each paper product may be compressed into a predetermined height. Then, the paper stack height of each manufactured paper product may be controlled to be uniform, so as to stabilize production condition of paper products. Thus, not only manufacturing quality of paper product may be enhanced, but also probability of failure in the production equipment may be reduced.

### FIELD OF THE INVENTION

The present invention relates to a means for compressing paper stack height and method for controlling paper stack height of paper product, particularly to a means for compressing and controlling paper stack height of paper product and method therefor.

### BACKGROUND

Currently, paper material for manufacturing cleaning paper product (e.g., tissue paper product, facial tissue paper product) may be generally rolled into a rolling manner. When paper material is rolled, the thickness of outer-layered paper material is often greater than that of inner-layered paper material owing to rolling and then pressing of the outer-layered paper material onto the inner-layered paper material.

In practical production, paper material in the rolling manner is used for manufacturing paper product, and paper products stacked with the same amount of paper are manufactured in turn. Furthermore, although each paper product is stacked with equal amount of paper, paper stack height of the paper product formerly manufactured from the outer-layered paper material is greater than that later manufactured from the inner-layered paper material, such that paper stack height of each paper product is not coincide with each other, due to the fact that thickness of the outer-layered paper material is greater than that of the inner-layered paper material in the same roll of paper material as described above.

An extreme instability in production condition may occur when difference is presented between paper stack height of each paper product, in which not only the manufacturing quality of paper product is impacted, but also the equipment is easily damaged and thus production efficiency is impacted.

### SUMMARY OF THE INVENTION

It is one object of the present invention to provide a means for compressing paper stack height and method for controlling paper stack height, comprising at least one pressurizer and at least one elevator, the elevator being allowed for adjusting up/down position of the pressurizer on the basis of paper stack height of paper product, correspondingly, the pressurizer in the adjusted position being allowed for pressurizing the paper product, in such a way that paper stack height of the pressurized paper product may be compressed into a predetermined height. Then, the paper stack height of each manufactured paper product may be controlled to be uniform, so as to stabilize production condition of paper products. Thus, not only manufacturing quality of paper product may be enhanced, but also probability of failure in the production equipment may be reduced.

It is one object of the present invention to provide a means for compressing paper stack height and method for controlling paper stack height, capable of inspecting paper stack height of paper product, in which the elevator is used for adjusting the position of the pressurizer on the basis of height difference between the inspected height and the predetermined height.

It is one object of the present invention to provide a means for compressing paper stack height and method for controlling paper stack height, capable of obtaining a variation in paper stack height between each paper product. After the highest paper product completed the pressurizing process by the pressurizer, the elevator is allowed to fine-tune the position of the pressurizer on the basis of the variation in paper stack height whenever the pressurizer is desired to continuously pressurize each paper product manufactured subsequently.

To achieve above objects, the present invention provides a means for compressing paper stack height of paper product, the means being used for compressing height of at least one paper product having a predetermined amount of stacked paper, comprising: at least one pressurizer, fixedly provided at the bottom thereof with a pressure plate, the pressurizer being provided for pressurizing the paper product via the pressure plate; and at least one elevator, to which the pressurizer is coupled, the elevator being allowed to adjust the up/down position of the pressurizer based on the paper stack height of paper product, in such a way that the pressurizer is capable of pressurizing the paper product in an appropriate position, thus compressing the paper stack height of the pressed paper product into a predetermined height.

In one embodiment of the present invention, further comprising a driving motor unit, the driving motor unit comprising a controller and a driving motor set, the driving motor set being electrically connected to the pressurizer and the elevator, the controller driving the pressurizer and the elevator to operate via the driving motor set.

In one embodiment of the present invention, further comprising a height detector electrically connected to the driving motor unit, the height detector detecting the paper stack height of paper product so as to obtain a detected height, a height difference being obtained by comparing the detected height with the predetermined height by the controller, so as to drive the elevator to adjust the position of the pressurizer, correspondingly, on the basis of the height difference.

In one embodiment of the present invention, wherein paper stack heights of an uncompressed highest paper product and/or lowest paper product may be obtained by the controller, the paper stack height of lowest paper product being set as the predetermined height.

In one embodiment of the present invention, wherein each paper product is manufactured orderly from the same roll of paper material, the highest paper product being an initially manufactured paper product, while the lowest paper product being a last manufactured paper product, the controller calculating a height difference in paper stack height between the height of the highest paper product and that of the lowest paper product, as well as obtaining a variation in paper stack height presented between each paper product manufactured orderly on the basis of the height difference in paper stack height, wherein after the highest paper product has completed the pressurizing process by the pressurizer, the controller will be used for driving the elevator to fine-tune the position of the pressurizer on the basis of the variation in paper stack height whenever the pressurizer is desired to pressurize each paper product manufactured subsequently.

In one embodiment of the present invention, wherein paper in the paper product is stacked in a flat or folded manner.

In one embodiment of the present invention, wherein the elevator comprises an elevating truss, to which the pressurizer is coupled.

In one embodiment of the present invention, further comprising at least one slide rail, coupled to the truss and fixedly provided at the bottom thereof with the pressure plate.

In one embodiment of the present invention, further comprising a coupling axle, wherein the elevators are linked together and the up/down position of each pressurizer is adjusted along with each other via the coupling axle.

In one embodiment of the present invention, wherein the paper product is transported by a delivery platform.

The present invention another provides a method for controlling paper stack height of paper product, the method being used for controlling height of at least one paper product having a predetermined amount of stacked paper, comprising: receiving the paper product; allowing an elevator to adjust the up/down position of a pressurizer, correspondingly, based on the paper stack height of paper product; and allowing the pressurizer to pressurize the paper product in an appropriate position, thus compressing the paper stack height of the pressed paper product into a predetermined height.

In one embodiment of the present invention, wherein allowing the elevator to adjust the up/down position of the pressurizer, correspondingly, based on the paper stack height of paper product comprises the steps of: detecting the paper stack height of paper product so as to obtain a detected height; comparing the detected height with the predetermined height to obtain a height difference; and driving the elevator so as to adjust the up/down position of the pressurizer, correspondingly, on the basis of the height difference.

In one embodiment of the present invention, further comprising one step of: obtaining samples of an uncompressed highest paper product and/or lowest paper product, and setting the paper stack height of lowest paper product as the predetermined height.

In one embodiment of the present invention, wherein each paper product is manufactured orderly from the same roll of paper material, the highest paper product being an initially manufactured paper product, while the lowest paper product being a last manufactured paper product, wherein allowing the elevator to adjust the up/down position of the pressurizer, correspondingly, based on each paper stack height of paper product comprises the steps of: calculating a height difference in paper stack height between the height of the highest paper product and that of the lowest paper product; obtaining a variation in paper stack height presented between each paper product manufactured orderly on the basis of the height difference in paper stack height; and after the highest paper product has completed the pressurizing process by the pressurizer, driving the elevator to fine-tune the position of the pressurizer on the basis of the variation in paper stack height whenever the pressurizer is desired to pressurize each paper product manufactured subsequently.

### BRIEF DESCRIPTION OF DRAWINGS

FIGS. 1(A)-(B) are a structural side view and a structural perspective view illustrating a pressurizing process of a means for compressing paper stack height of paper product according to one preferred embodiment of the present invention.

FIGS. 2(A) to (B) are a structural side view and a structural perspective view illustrating another pressurizing process of a means for compressing paper stack height of paper product of the present invention.

### DETAILED DESCRIPTION

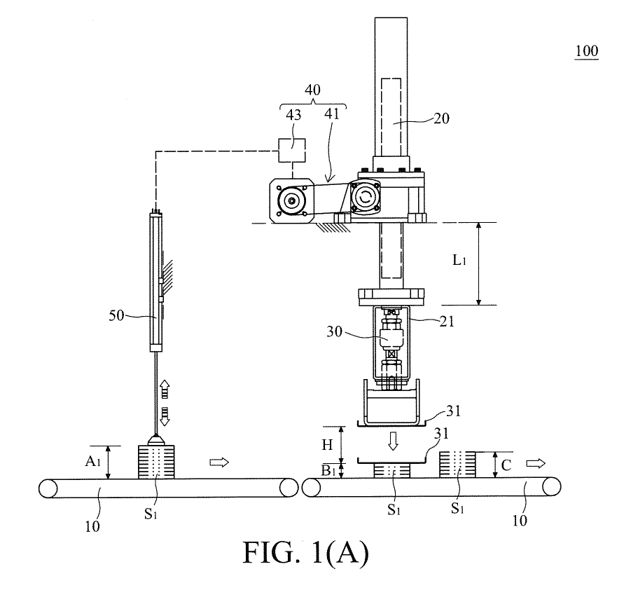

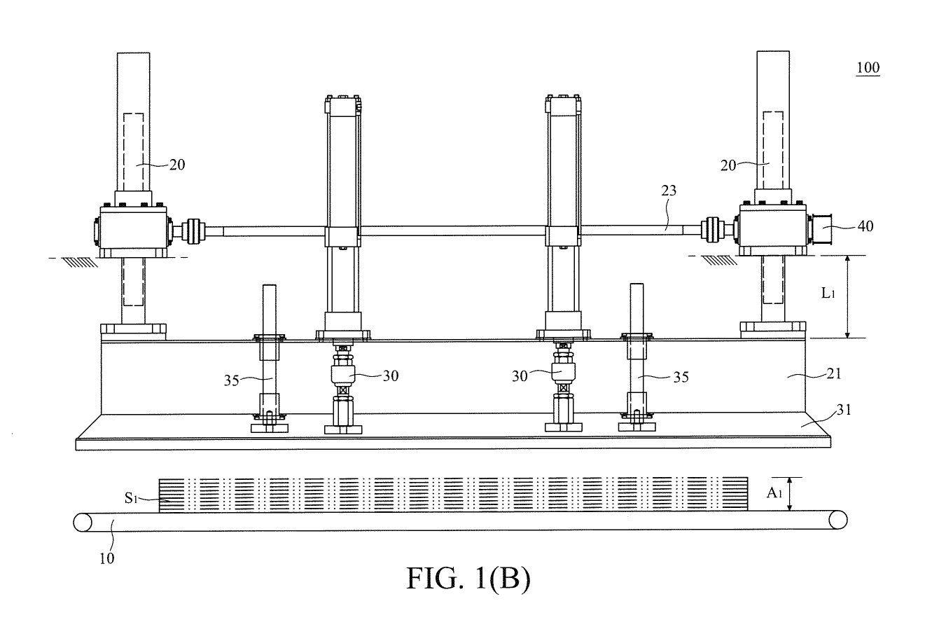

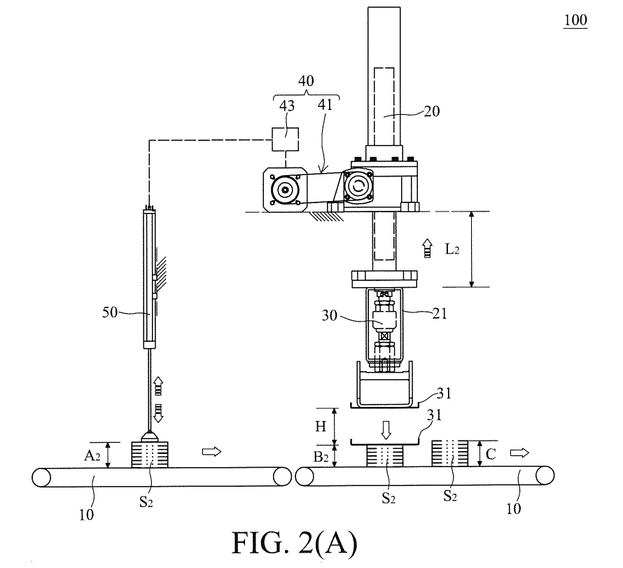

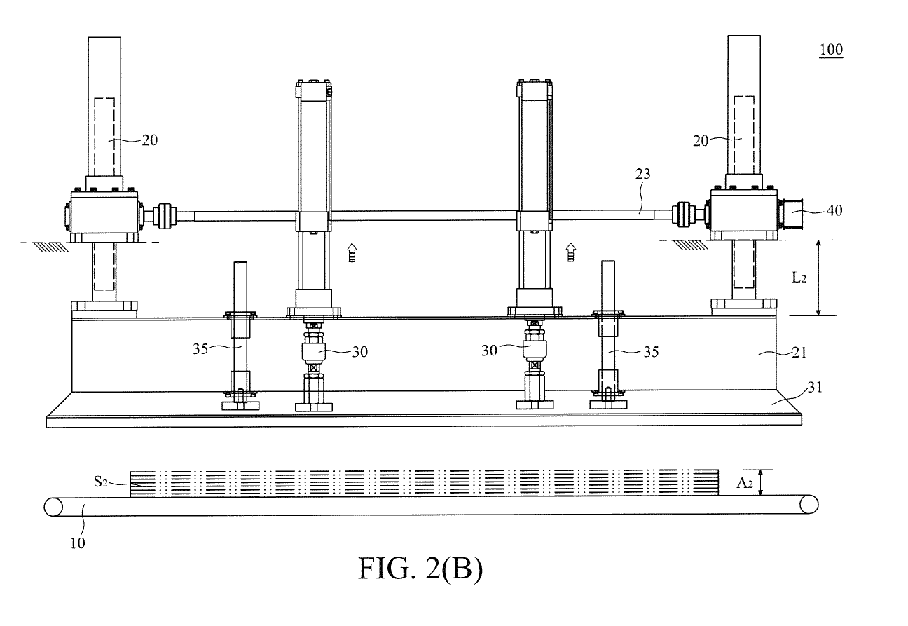

FIGS. 1(A) to (B) and FIGS. 2(A) to (B) are a structural side view and a structural perspective view illustrating a pressurizing process of a means for compressing paper stack height of paper product according to one preferred embodiment of the present invention, as well as a structural side view and a structural perspective view illustrating another pressurizing process. As illustrated in the figures, a delivery platform 10 is provided under the means for compressing paper stack height 100. The delivery platform 10 is used for the transportation of each paper product S₁, S₂, . . . S_{N-1}, S_{N}, each S₁, S₂, . . . S_{N-1}, S_{N} being manufactured, in turn, from paper material in a rolling manner. In each paper product S₁, S₂, . . . S_{N-1}, S_{N}, an identical amount of stacked paper is provided, and paper is stacked in a flat or folded manner. In this case, the means for compressing paper stack height 100 may be provided for pressurizing each paper product S₁, S₂, . . . S_{N-1}, S_{N}, in turn, transported by the delivery platform 10, in such a way that the paper stack height of each paper product S₁, S₂, . . . S_{N-1}, S_{N} may be compressed into a predetermined height (C).

The main construction of the means for compressing paper stack height 100 comprises at least one elevator 20 and at least one pressurizer 30. The pressurizer 30 is connectedly fixed to the elevator 20, and the up/down position of the pressurizer 30 is then adjusted via the up/down motion of the elevator 20. The bottom of the pressurizer 30 is fixedly provided with a pressure plate 31. The pressurizer 30 is used for pressurizing each paper product S₁, S₂, . . . S_{N-1}, S_{N} via the pressure plate 31. The bottom of the elevator 20 is provided with an elevating truss 21, the pressurizer 30 is connectedly fixed to the elevating truss 21 of the elevator 20. In this case, the elevator 20 of the present invention is allowed to adjust the up/down position of the pressurizer 30, correspondingly, based on the paper stack height of each paper product S₁, S₂, . . . S_{N-1}, S_{N}, in such a way that the pressurizer 30 is capable of providing a corresponding pressing amount to pressurize each paper product S₁, S₂, . . . S_{N-1}, S_{N} in an appropriate position. Thus, the paper stack height of each pressed paper product S₁, S₂, . . . S_{N-1}, S_{N} may be compressed into a predetermined height (C).

As illustrated in the prior art, furthermore, thickness of outer-layered paper material is greater than that of inner-layered paper material in the same roll of paper material, and thus the paper stack height of paper product formerly manufactured from the outer-layered paper material is greater than that of the paper product later manufactured from the inner-layered paper material. In other words, in the same roll of paper material, the initially manufactured paper product is formed with the highest paper stack height, while the last manufactured paper product is formed with the lowest paper stack height. In this case, the sample of an uncompressed highest paper product S₁ (e.g., initially manufactured paper product) and/or lowest paper product S_{N} (e.g., the last manufactured paper product) may be obtained previously by the means for compressing paper stack height 100 of the present invention, and the paper stack height of the lowest paper product S_{N} is then served as the basis for setting this predetermined height (C) in the present invention, such that the paper stack height of each manufactured paper product S₁, S₂, . . . S_{N-1}, S_{N} is desirably equivalent to the paper stack height of the lowest paper product S_{N}.

Moreover, the means for compressing paper stack height 100 further comprises a driving motor unit 40. This driving motor unit 40 comprises a driving motor set 41 and a controller 43. The driving motor set 41 is electrically connected to the elevator 20 and the pressurizer 30. The controller 43 is allowed to drive the pressurizer 30 to pressurize each paper product S₁, S₂, . . . S_{N-1}, S_{N}, or drive the elevator 20 to adjust the up/down position of the pressurizer 30 via the driving motor set 41. Moreover, in one preferred embodiment of the present invention, the means for compressing paper stack height 100 further comprises a height detector 50 electrically connected to the driving motor unit 40. The height detector 50 is used to detect the paper stack height of paper product S so as to obtain a detected height (A). By comparing the detected height (A) of paper product S with the predetermined height (C), a height difference (D) therebetween may be obtained by the controller 43. Afterward, the controller 43 may drive the elevator 20 to adjust the up/down position of the pressurizer 30 on the basis of the height difference (D), correspondingly.

Next, a pressurizing process performed on each paper product S₁, S₂, . . . S_{N-1}, S_{N}, comprises the detailed steps as follows: firstly, as illustrated in FIGS. 1(A) to (B), manufacturing each paper product S₁, S₂, . . . S_{N-1}, S_{N}, from paper material in a rolling manner and delivering a formerly manufactured paper product S₁ by the delivery platform 10. The height detector 50 is used to detect the paper stack height of this formerly manufactured paper product S₁, so as to obtain a detected height (A₁). The controller 43 is allowed to compare the detected height (A₁) with the predetermined height (C), so as to obtain a height difference (A₁−C=D₁). In the controller 43, the pressing amount with respect to this paper product S₁ is determined on the basis of this height difference (D₁), and the driving motor set 41 is then requested to drive the elevator 20 to adjust the position of pressurizer 30, correspondingly, by the determined pressing amount. For instance, the interval between the main body of the pressurizer 30 and that of the elevator 20 is adjusted as a vertical length (L₁).

After the position of pressurizer 30 is adjusted, pressurizing operation is performed on the paper product S₁ in an appropriate position. The pressure plate 31 is used to pressurize downward until a compression depth (H) is reached, in such a way that the paper stack height of paper product S₁ is compressed to height (B₁) from the height (A₁). On the completion of pressurizing operation of the pressurizer 30 performed on the paper product S₁, the pressure plate 31 is separated upward, and the paper stack height of the paper product S₁ is then bounced to the predetermined height (C) from the height (B₁) being compressed. Thus, the paper stack height of the paper product S₁ may be compressed into the predetermined height (C) successfully after this paper product S₁ is pressurized.

Subsequently, as illustrated in FIGS. 2(A) to (B), the same roll of paper material is used continuously to produce another paper product S₂. This later manufactured paper product S₂ is similarly delivered by the delivery platform 10. The height detector 50 is allowed to detect the paper stack height of this later manufactured paper product S₂, so as to obtain a detected height (A₂). The detected height (A₂) of this later manufactured paper product S₂ is smaller than the detected height (A₁) of the formerly manufactured paper product S₁, such as A₂<A₁, for example, due to the fact that this later manufactured paper product is manufactured from relatively inner-layered paper material. In this way, height difference (A₂−C=D₂) between the detected height (A₂) of the paper product S₂ and the predetermined height (C) is also smaller than the previous height difference (A₁−C=D₁) between the detected height (A₁) of the paper product S₁ and the predetermined height (C), such as D₂<D₁, for example. The controller 43 is allowed to decrease the pressing amount with respect to the paper product S₂, correspondingly, on the basis of this smaller height difference (D₂), and then request the driving motor set 41 to drive the elevator 20 upward so as to elevate the position of the pressurizer 30. For instance, the interval between the elevated main body of pressurizer 30 and the main body of elevator 20 is adjusted as a vertical length (L₂) smaller than the vertical length (L₁).

After the pressurizer 30 is elevated upward, the pressurizing operation is performed on the paper product S₂ in the elevated position, and the pressure plate 31 is used to pressurize downward until a compression depth (H) is reached, in such a way that the paper stack height of the paper product S₂ may be compressed to height (B₂) from the height (A₂). On the completion of pressurizing operation of the pressurizer 30 performed on the paper product S₂, the pressure plate 31 is separated upward, and the paper stack height of the paper product S₂ is then bounced to the predetermined height (C) from the height (B₂) being compressed. Thus, the paper stack height of the paper product S₂ may be compressed into the predetermined height (C) successfully after this paper product S₂ is pressurized.

On proceeding with above procedures, the position of the pressurizer 30 may be adjusted upward gradually by the elevator 20, thus decreasing the pressing amount of the pressurizer 30, in such a way that the paper stack height of the paper product S₃. . . S_{N-1}, S_{N} manufactured from the same roll of paper material subsequently may be controlled to the predetermined height (C) via appropriate pressurization.

In this case, the paper stack height of each manufactured paper product S₁, S₂, . . . S_{N-1}, S_{N} may be controlled to be uniform via pressurizing process, so as to stabilize production condition of paper products S₁, S₂, . . . S_{N-1}, S_{N}. Thus, not only manufacturing quality of paper products S₁, S₂, . . . S_{N-1}, S_{N} may be enhanced, but also probability of failure in the production equipment may be then reduced.

In a further embodiment of the present invention, the means for compressing paper stack height 100 further comprises at least one slide rail 35. The slide rail 35 is coupled to the truss 21 and fixedly provided at the bottom thereof with the pressure plate 31. The elevator 20 is facilitated to adjust the position of the pressurizer 30 by the provision of the slide rail 35.

The number of elevators 20, pressurizers 30 and/or slide rails 35 being provided in the means for compressing paper stack height 100 of the present invention may be increased to, for instance, two, on the basis of size of paper for paper product S, correspondingly. Furthermore, the elevators 20 may be linked together with a coupling axle 23, such that up/down motion of one of the elevators 20 is capable of leading the other elevators 20 to move along therewith via the coupling axle 23, for simultaneous adjustment of the position of each pressurizer 30 by each elevator 20.

Furthermore, in the above embodiments of the present invention, it is necessary for the height detector 50 to detect paper stack height of paper product S₁, S₂, . . . S_{N-1}, S_{N} (e.g., detected height (A)) before each pressurizing process performed on the paper product S₁, S₂, . . . S_{N-1}, S_{N}, and the position of the pressurizer 30 may be adjusted on the basis of the height difference (D) between the detected height (A) and the predetermined height (C), correspondingly.

Besides using the height difference (D) between the detected height (A) of paper product S₁, S₂, . . . S_{N-1}, S_{N} and the predetermined height (C) to adjust the position of pressurizer 30, alternatively, it is also possible to selectively use variation in paper stack height (V) between each paper product S₁, S₂, . . . S_{N-1}, S_{N} to adjust the position of the pressurizer 30 in a further embodiment of the present invention, which is operated in the way as follows.

Next, paper products S₁, S₂, . . . S_{N-1}, S_{N} with different paper stack heights may be manufactured orderly when the paper products are manufactured from the same roll of paper material. In the paper products S₁, S₂, . . . S_{N-1}, S_{N} manufactured orderly, the paper stack height of each of them may be varied linearly, with the highest paper stack height provided for the initially manufactured paper product S₁, while the lowest paper stack height provided for the last manufactured paper product S_{N}. In this case, a controller 43 is allowed to previously obtain the paper stack heights of uncompressed highest paper product S₁ and lowest paper product S_{N}, calculate height difference in paper stack height (A₁−A_{N}) between the height of the highest paper product S₁ and that of the lowest paper product S_{N}, as well as obtain variation in paper stack height (V) presented between each paper product S₁, S₂, . . . S_{N-1}, S_{N} , manufactured orderly on the basis of the difference in paper stack height (A₁−A_{N}), e.g., V=(A₁−A_{N})/(N−1).

After the highest paper product S₁ has completed the pressurizing process by the pressurizer 30 (e.g., as illustrated in FIGS. 1(A) to (B)), then the controller 43 is allowed to drive the elevator 20 to elevate the position of the pressurizer 30 gradually, on the basis of the variation in paper stack height (V), so as to decrease the pressing amount of the pressurizer 30 in turn, whenever the pressurizer 30 is desired to continuously pressurize each paper product S₂, . . . S_{N-1}, S_{N} manufactured subsequently. In this way, the paper stack height of each paper product S₂, . . . S_{N-1}, S_{N} manufactured from the same roll of paper material subsequently may be controlled to the predetermined height (C) via appropriate pressurization. Furthermore, this operating step of fine-tuning the position of the pressurizer 30 on the basis of the variation in paper stack height (V) between each paper product S₁, S₂, . . . S_{N-1}, S_{N} may be repeated, until the pressurizing process proceeds to the lowest paper product S_{N}. In this case, the step of inspecting paper stack heights of paper products S₂, . . . S_{N-1}, S_{N} may be saved due to the adjustment of the position of the pressurizer 30 on the basis of the obtained variation in paper stack height (V), thus increasing the production efficiency of paper products S.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A means for compressing paper stack height of paper product, said means being used for compressing height of at least one paper product having a predetermined amount of stacked paper, comprising:
at least one pressurizer, fixedly provided at the bottom thereof with a pressure plate, said pressurizer being provided for pressurizing said paper product via said pressure plate; and
at least one elevator, to which said pressurizer is coupled, said elevator being allowed to adjust the up/down position of said pressurizer based on said paper stack height of paper product, in such a way that said pressurizer is capable of pressurizing said paper product in an appropriate position, thus compressing said paper stack height of said pressed paper product into a predetermined height.

2. The means for compressing paper stack height according to claim 1, further comprising a driving motor unit, said driving motor unit comprising a controller and a driving motor set, said driving motor set being electrically connected to said pressurizer and said elevator, said controller driving said pressurizer and said elevator via said driving motor set.

3. The means for compressing paper stack height according to claim 2, further comprising a height detector electrically connected to said driving motor unit, said height detector detecting said paper stack height of paper product so as to obtain a detected height, a height difference being obtained by comparing said detected height with said predetermined height by said controller, so as to drive said elevator to adjust the position of said pressurizer, correspondingly, on the basis of said height difference.

4. The means for compressing paper stack height according to claim 2, wherein paper stack heights of an uncompressed highest paper product and/or lowest paper product may be obtained by said controller, said paper stack height of lowest paper product being set as said predetermined height.

5. The means for compressing paper stack height according to claim 4, wherein each paper product is manufactured orderly from the same roll of paper material, said highest paper product being an initially manufactured paper product, while said lowest paper product being a last manufactured paper product, said controller calculating a height difference in paper stack height between the height of said highest paper product and that of said lowest paper product, as well as obtaining a variation in paper stack height presented between each paper product manufactured orderly on the basis of said height difference in paper stack height, wherein after said highest paper product has completed the pressurizing process by said pressurizer, said controller will be used for driving said elevator to fine-tune the position of said pressurizer on the basis of said variation in paper stack height whenever said pressurizer is desired to pressurize each paper product manufactured subsequently.

6. The means for compressing paper stack height according to claim 1, wherein paper in said paper product is stacked in a flat or folded manner.

7. The means for compressing paper stack height according to claim 1, wherein said elevator comprises an elevating truss, to which said pressurizer is coupled.

8. The means for compressing paper stack height according to claim 7, further comprising at least one slide rail, coupled to said truss and fixedly provided at the bottom thereof with said pressure plate.

9. The means for compressing paper stack height according to claim 1, further comprising a coupling axle, wherein said elevators are linked together and the up/down position of each pressurizer is adjusted along with each other via said coupling axle.

10. The means for compressing paper stack height according to claim 1, wherein said paper product is transported by a delivery platform.

11. A method for controlling paper stack height of paper product, said method being used for controlling height of at least one paper product having a predetermined amount of stacked paper, comprising:
receiving said paper product;
allowing an elevator to adjust the up/down position of a pressurizer, correspondingly, based on said paper stack height of paper product; and
allowing said pressurizer to pressurize said paper product in an appropriate position, thus compressing said paper stack height of said pressed paper product into a predetermined height.

12. The method for controlling paper stack height according to claim 11, wherein allowing said elevator to adjust the up/down position of said pressurizer, correspondingly, based on said paper stack height of paper product comprises the steps of:
detecting said paper stack height of paper product so as to obtain a detected height;
comparing said detected height with said predetermined height to obtain a height difference; and
driving said elevator so as to adjust the up/down position of said pressurizer, correspondingly, on the basis of said height difference.

13. The method for controlling paper stack height according to claim 11, further comprising one step of:
obtaining samples of an uncompressed highest paper product and/or lowest paper product, and setting said paper stack height of lowest paper product as said predetermined height.

14. The method for controlling paper stack height according to claim 13, wherein each paper product is manufactured orderly from the same roll of paper material, said highest paper product being an initially manufactured paper product, while said lowest paper product being a last manufactured paper product, wherein allowing said elevator to adjust the up/down position of said pressurizer, correspondingly, based on each paper stack height of paper product comprises the steps of:
calculating a height difference in paper stack height between the height of said highest paper product and that of said lowest paper product;
obtaining a variation in paper stack height presented between each paper product manufactured orderly on the basis of said height difference in paper stack height; and
after said highest paper product has completed the pressurizing process by said pressurizer, driving said elevator to fine-tune the position of said pressurizer on the basis of said variation in paper stack height whenever said pressurizer is desired to pressurize each paper product manufactured subsequently.
